(19) United States
(12) Patent Application Publication
(10) Pub. No.: US 2015/0381732 A1
(43) Pub. Date: Dec. 31, 2015

(54) TECHNIQUES FOR MANAGING CONTENT ITEMS ASSOCIATED WITH PERSONAS OF A MULTIPLE-PERSONA MOBILE TECHNOLOGY PLATFORM

(71) Applicant: CELLROX, LTD., Tel Aviv (IL)

(72) Inventors: Offir GONEN, Ramat Hasharon (IL); Oren LAADAN, New York, NY (US); Amir GOLDSTEIN, Tel Aviv (IL)

(73) Assignee: CELLROX, LTD., Tel Aviv (IL)

(21) Appl. No.: 14/751,457

(22) Filed: Jun. 26, 2015

Related U.S. Application Data
(60) Provisional application No. 62/017,420, filed on Jun. 26, 2014.

(51) Int. Cl. H04L 29/08

(52) U.S. Cl. CPC H04L 67/1097; H04L 67/306

(57) ABSTRACT

A method and system for managing content items associated with personas of a multiple-persona mobile technology platform (MTP) are provided. The method includes receiving a request to perform an action on a content item associated with a first persona of a plurality of personas defined in the MTP, wherein the request is generated by the first persona; identifying at least a second persona of the plurality of personas defined in the MTP is linked to the content item; performing the requested action, when the at least second persona is not linked to the content item; and managing a link between the first persona and the content item, when the at least second persona is linked to the content item.

### CROSS-REFERENCE TO RELATED APPLICATIONS

This application claims the benefit of U.S. Provisional Application No. 62/017,420 filed on Jun. 26, 2014, the contents of which are hereby incorporated by reference.

### TECHNICAL FIELD

The present disclosure relates generally to a multiple-persona mobile technology platform (MTP), and more specifically, to techniques for managing content items stored by personas on the MTP.

### BACKGROUND

When using a multiple-persona mobile technology platform (MTP) to install, store, update, or remove content items, a proper content store management system is required to adjust the use of a content item to a different set of personas and to a user of the MTP. For example, one user may prefer to use a specific version of a content item with a first persona and a different version of the same content item with a second persona. As another example, a user may prefer that only one version of a content item will be stored on the MTP regardless of the personas configured by such MTP. This is because keeping multiple copies of a content item can be time consuming, disturbing to the user, a waste of memory and resources, and so on. A content item may be an application, a service, a media file (e.g., a picture, a document), a bookmark, blob (e.g., ODEX file), or a document.

The use of content items by multiple personas of an MTP presents challenges for both the users and the service providers. Each time a new persona is created by a user of the MTP, this requires a service provider to offer the user to store, install, and/or configure the content items in the new persona. The service provider offers the storage of the content items even though such content items are already in use by the MTP. Also, when a new content item is created and/or stored by one of the personas, the user may need to re-do the same steps in other personas. Moreover, each time an update of a content item is available the service provider of the MTP is required to notify each one of the personas of the available update. The new content item should be updated in each of the personas.

It would therefore be advantageous to provide an efficient solution for managing content items on multiple personas of an MTP.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

Some of embodiments of the disclosure relate to a method for managing content items associated with personas of a multiple-persona mobile technology platform (MTP). The method comprises receiving a request to perform an action on a content item associated with a first persona of a plurality of personas defined in the MTP, wherein the request is generated by the first persona; identifying at least a second persona of the plurality of personas defined in the MTP is linked to the content item; performing the requested action, when the at least second persona is not linked to the content item; and managing a link between the first persona and the content item, when the at least second persona is linked to the content item.

Some of embodiments of the disclosure also relate to a multiple-persona mobile technology platform (MTP) for managing content items. The MTP comprises a processing unit; and a memory, the memory containing instructions that, when executed by the processing unit, configure the MTP to: receive a request to perform an action on a content item associated with the first persona of a plurality of personas defined in the MTP, wherein the request is generated by the first persona; identify at least second persona of the plurality of personas defined in the MTP is linked to the content item; perform the requested action, when the at least second person is not linked to the content item; and manage a link between the first persona and the content item, when the at least second persona is linked to the content item.

### BRIEF DESCRIPTION OF THE DRAWINGS

The subject matter disclosed herein is particularly pointed out and distinctly claimed in the claims at the conclusion of the specification. The foregoing and other objects, features and advantages of the disclosed embodiments will be apparent from the following detailed description taken in conjunction with the accompanying drawings.

FIG. 1 is a schematic block diagram of a system utilized to describe the various disclosed embodiments.

FIG. 2 is a schematic diagram utilized to describe the linkage of content items between two personas according to an embodiment.

FIG. 3 is a flowchart describing a method for storing a content item by a persona of a MTP according to an embodiment.

FIG. 4 is a flowchart describing a method for updating a content item by a persona of a MTP according to an embodiment.

FIG. 5 is a flowchart describing a method for removing a content item by a persona of a MTP according to an embodiment.

### DETAILED DESCRIPTION

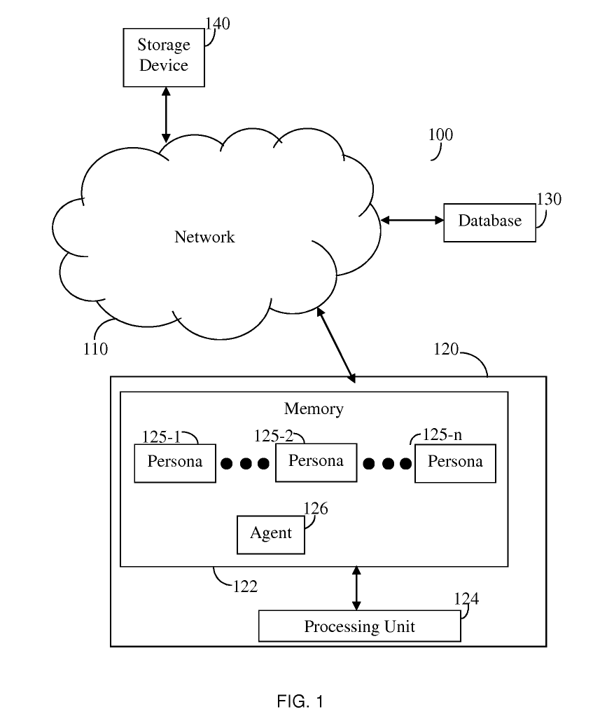

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views. FIG. 1 is an exemplary and non-limiting schematic diagram of a networked system 100 utilized to describe the various embodiments disclosed herein. The networked system 100 includes a network 110 and a multiple-persona mobile technology platform (MTP) 120 communicatively connected to the network 110. The network 110 may be a local area network (LAN), a system area network (SAN), a wide area network (WAN), a metro area network (MAN), the worldwide web (WWW), the Internet, implemented as wired and/or wireless networks, and any combinations thereof. The MTP 120 is a computing device including a processing unit 122 and memory 124. The MTP 120 may be, but is not limited to, a tablet computer, a laptop computer, a smartphone, a cellular phone, a notebook computer, an intra-vehicle infotainment system (IVI), a wearable computing device, and the like.

In an embodiment, each MTP 120 is configured with a plurality of personas, for example, persona 125-1 through persona 125-n (n is an integer greater than 1). A persona refers to at least one role or identity associated with and assumable by a user of the MTP 120. The roles or identities of the user correspond to a unique execution environment. The execution environment may be a virtual execution environment, an operating system, a sandbox, a userspace container, a hypervisor, or any combination thereof. Each persona 125 is associated with a unique set of metadata.

In an embodiment, a persona is a user profile defined as part of an operating system supporting a multiple-user feature in the MTP 120. Such a user profile is maintained and monitored by the MTP's 120 operating system and allows the user to define under each profile a set of specific applications (apps), passwords, and other lock mechanisms associated with a specific user of the profile. For example, one user profile may be set for the owner of the MTP 120 where all applications are available and another profile for a child using the MTP 120 where only games may be available.

In certain configurations, the MTP 120 further includes an agent 126 installed therein. The agent 126 may be executable code that is associated with the memory 124 and executed by the processing unit 122. Alternatively to the agent 126, a script that is supported by an operating system (OS) of the MTP 120 may be used. The various embodiments for managing content items associated with personas 125 are performed by the script or performed by the control of the agent 126. In further certain configurations, the agent 126 may be any service running outside of a persona or in a persona.

The memory 124 of the MTP 120 further includes instructions, settings, rules configurations, and/or images of each persona 125. The memory 124 may additionally store content items associated and/or accessed by each particular persona 125. It should be noted that a content item associated with the memory 124 and associated with one persona is not associated with the other personas. A content item may be an application, a service, a media file, a bookmark, blob (e.g., ODEX file), and the like.

The processing unit 122 is communicatively connected to the memory 124. The processing element 122 is configured to execute, among others, the instructions of the agent 126 and any of the instructions for enabling the operation of the personas 125, and the processes for managing content items accessible by the personas 125 according to an embodiment.

The processing unit 122 may include one or more processors. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

In an embodiment, the memory 124 may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code).

According to an embodiment, the MTP 120 is configured to receive a set of user preferences defining how to handle a content item or a group of content items (e.g., all blobs) associated with each persona 125. These preferences may be configured by information technology (IT) personnel, a security policy, a server external to the MTP 120, a user of the MTP 120, and the like. In an embodiment, the user preferences are associated with the memory 124. In another embodiment, the user preferences defined for all personas 125 may be also saved in a database 130. The database 130 is connected to the MTP 120 as an external component via the network 110.

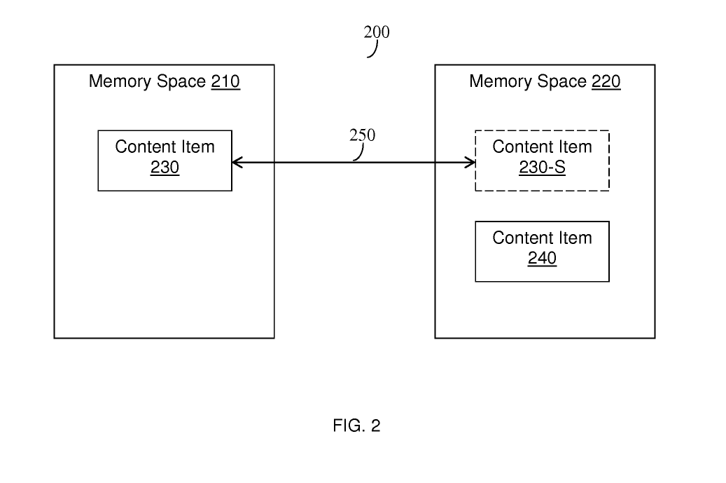

Also connected to the network 110 is a storage device 140 that may be utilized to store content items accessible by the personas 125. The storage device 140 may be, but is not limited to, a network attached storage device, a distributed storage system, a cloud storage, and the like. In an embodiment, a memory space is associated with each persona 125. The memory space may be part of the local memory 124, the storage device 140, or a combination thereof. As will be discussed in further detail below with reference to FIG. 2, content items associated with a particular persona 125 are saved in the memory space associated with the persona 125. It should be noted that association of a memory space to a persona 125 may include, for example, a physical memory allocation to a persona 125, a virtual memory allocation to a persona 125, or assigning a particular section in a common memory of the MTP 120 visible to the persona 125 only.

As a non-limiting example, the user preferences define the following actions on a content item(s) of a particular persona 125: automatic update, removal, storage, sharing, and/or browsing of the content item(s). As another non-limiting example, the user preferences may define generating a link to a stored content item upon identification of one or more environmental parameters. An environmental parameter, may include, for example, a location of the MTP 120, time information at the location of the MTP 120, temperature respective of the location, proximity of the MTP 120 to one or more objects, level of environmental light, level of environmental sound, and so on.

Additionally or collectively, the user preferences may define permissions required to share content items between personas 125 upon identifying a similar content item (e.g., permissions to access a content item in a foreground persona 125 and background persona 125), generate links to content items visible and/or unviable, suggest to remove similar content items identified in a plurality of personas 125, and so on.

According to an embodiment, personas 125 can share content items by generating links between personas 125 and content items. Each such link enables a persona 125, to which the link is generated, to access a particular content item. The link may be, for example, symbolic (indirect) or hard links. A symbolic (indirect) link is a logical reference to a file in a form of a filename pointing to another filename e.g., a shortcut in a Windows® operating system. Unlike hard links, a symbolic link does not point to a file, but rather to another filename.

In another embodiment, a link can be realized by a bind mount that enables a particular content item associated with a memory space dedicated to one persona 125 to be visible in another memory space dedicated to another persona 125.

In yet another embodiment, content items can be shared among personas 125 by means of common synchronization (sync) protocols or a file system configured to perform deduplication and copy-on-write. The file system may be a local or a remote file system, examples of which include a network file system (NFS), Google Drive™, Dropbox®, and the like.

According to another embodiment, when a content item is shared between a plurality of personas 125, changes to the content item may be propagated to such personas 125. This is performed according to definitions set in the user preferences associated with each one of the personas 125.

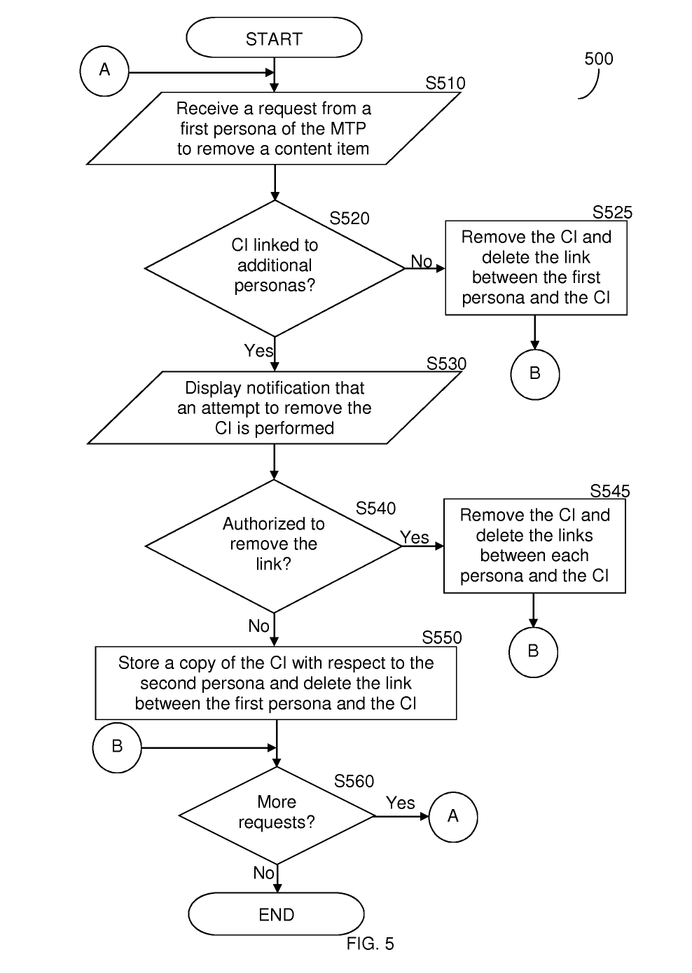

According to yet another embodiment, upon receiving a request from one persona 125 to change a content item that is shared between multiple other personas, the changes may be performed with respect to the requesting persona, while an unchanged copy is stored and accessible by the other personas 125 (that the content item has been shared with). Sharing a modified and/or unmodified content item is performed respective of user preferences and/or the unique set of rules associated with each persona 125. This embodiment is described in greater detail herein below with reference to FIG. 5.

FIG. 2 provides a schematic diagram 200 utilized to describe the linkage of content items between two personas according to an embodiment. In the exemplary FIG. 2, a memory space 210 is associated with a persona 125-1 and a memory space 220 is associated with a persona 125-2. Each of the memory spaces may be part of the local memory 124, the storage device 140, or combination thereof.

A content item 230 is saved in the memory space 210 of the persona 125-1. As an example, the content item 230 may be a file saved by a personal persona (persona 125-1) in a Dropbox® travel folder. When, a business persona (persona 125-2) attempts to save a content item (content item 230-S) it is checked if it is already existing in the memory space of the other personas. In this example, both content items 230 and 230-S are the same, thus a link 250 is generated between the content item 230 in the memory space 210 to the persona 125-1 to the content item 230-S in the memory space 220 of the persona 125-2. As will be discussed below, a link 250 is generated only upon checking if the persona 125-2 can access the content item 230.

As another example, the persona 125-2 attempts to store a content item 240 in the memory space 220. The content item 240 was not previously associated with the memory space 210, thus a copy the content item 240 is saved on the memory space 220 of the persona 125-2.

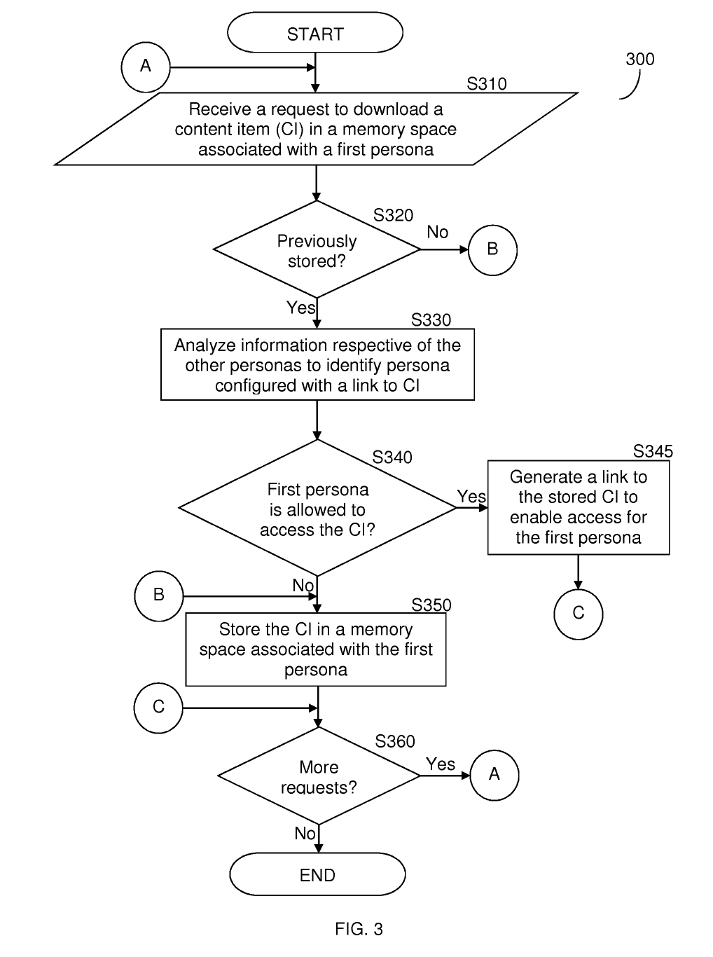

FIG. 3 shows an exemplary and non-limiting flowchart 300 illustrating a method for storing content items by a persona of a MTP according to an embodiment. Without limiting the scope of the disclosed embodiments, the method will be described also with references to the various elements illustrated in FIG. 1. Further for the sake of simplicity of the description, the method will be described with a reference to a first persona 125-1 a second persona 125-2.

In S310, a request from a first persona 125-1 to download or store a content item in a memory space associated with the first persona is received. It should be noted that association of a memory space to a persona may include, for example, physical memory allocation to a persona, virtual memory allocation to a persona, or assigning a particular section in a common memory visible to the persona only. The request is received, for example, by the agent 126. According to an embodiment, the request may also be sent from a component of the MTP 120 that is not a persona or from an external component communicatively connected to the MTP 120.

The content item to be saved may be produced by the first persona 125-1 using the MTP 120 (e.g., taking a picture by the camera of the MTP 120), downloaded from an external entity communicatively connected to the MTP 120 (e.g., downloading an application to be installed on the MTP 120), and/or received from a script running on a webpage downloaded to the MTP 120.

In S320, it is checked whether the content item was previously associated with a memory space associated with any of the other personas 125-2 through 125-n. If so, execution continues with S330; otherwise, execution proceeds to S350. In S330, information respective of the “other” personas 125-2 through 125-n is analyzed to identify at least one persona of the personas 125-2 through 125-n having a link to the content item. The analysis in S330 is performed using the set of user preferences and/or rules defined or otherwise associated with each persona. Merely for the sake of simplicity of the description and without limiting the scope of the disclosed embodiments, the identified persona will be referred to the second persona 125-2.

In S340, it is checked whether there is a permission for the persona 125-1 to access the content item associated with a memory space of the second persona 125-2. If so execution continues with S345; otherwise, execution continues with S350. The check in S340 is performed based on the user preferences set for the second persona 125-2.

In S345, a link to the stored content item is generated to enable the access of the persona 125-1 to the content item associated with a memory space of the second persona 125-2, and thereafter execution continues with S360. According to an embodiment, a bind mount, a common sync protocol, or a filesystem can be used to enable the content item to be accessed by persona 125-1. In such embodiment, the link is generated using the techniques known in the art to link objects using a bind mount, a common sync protocol, or a fliesystem type of a link as described above.

Execution reaches S350 when the content item was not previously saved in the memory space of the second persona 125-2 or an access to a stored content item is not allowed. In S350, the content item is associated with a memory space associated with the first persona 125-1, thereby allowing the persona 125-1 to access the content item. In another embodiment, the content item is stored in a shared memory that is not assigned or associated with a particular persona. The content item stored in the shared memory is merely linked to a persona requested to store the file (e.g., persona 125-1)

In an embodiment, a link is generated between the stored content item and the first persona 125-1. The link may be determined to be visible or not according to the user preferences set for the first persona 125-1. According to an embodiment, the content item may be encoded upon demand. According to another embodiment, a notification may be displayed to the user of the MTP 120 respective of a visible link. Such notification may be displayed on an interface dedicated to the persona 125-1, offering to use the content item, rather than performing an automatic connection to the link.

In S360, it is checked whether there are additional requests and if so execution continues with S310; otherwise, execution terminates.

According to a non-limiting embodiment, the content item stored respective of the persona 125-1 may be shared with other personas 125 respective of, for example, the set of permissions and/or the unique set of rules associated with each one of the personas 125.

According to an embodiment, when a content item is stored upon receiving a request from the persona 125-1, the content item may be shared with the second persona 125-2 without sharing data related to such content item. For example, the APK and the ODEX of an application may be shared while the data is not shared. As another example, an Angry Birds® application can be shared between the first persona 125-1 and the second persona 125-2, but each one of the personas 125-1, 125-2 may have a link to the data associated with the Angry Birds® application.

According to another embodiment, upon generation of a new persona, content items stored on the MTP 120 may be linked to the new persona. Which content items are determined based on the set of preferences and/or a unique set of rules associated with the new persona.

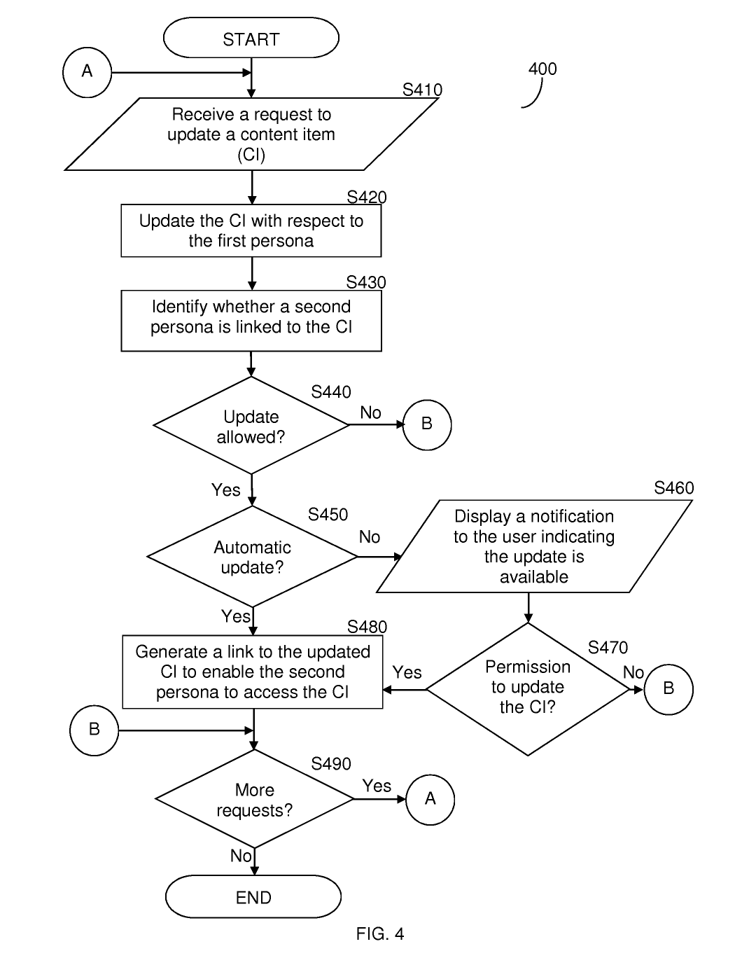

FIG. 4 shows an exemplary and non-limiting flowchart 400 illustrating a method for updating content items stored by a persona of a MTP according to an embodiment. Without limiting the scope of the disclosed embodiments, the method will be described also with references to the various elements illustrated in FIG. 1. Further for the sake of simplicity of the description, the method will be described with reference to a first persona 125-1 and a second persona 125-2.

In S410, a request to update a content item is received. The request may be sent by an application of a first persona 125-1, a component of the MTP 120 that is not the first persona 125-1, an external component communicatively connected to the MTP 120, and so on. The content item is saved in a memory space to the first persona 125-1. The content item may be bound to the persona 125-1 or it may be linked to the persona 125-1 to allow the access to such content item respective thereof. For example, the first persona 125-1 can request to update a picture that was taken by the camera of the MTP 120 or update an application installed on the MTP 120.

In S420, the content item saved in the memory space associated with first persona 125-1 is updated with respect to the first persona. According to a non-limiting embodiment, a link may be generated to the updated content item to enable the access associated with first persona 125-1 respective thereof. According to another non-limiting example, a bind mount is performed respective of the updated content item to enable the content item to be accessible by the first persona 125-1.

In S430, at least one persona of the personas 125-2 through 125-n having a link to the content item is identified. The identification analysis in S430 is performed using the user preferences and/or rules defined or otherwise associated with each of the personas 125-2 through 125-n. Merely for the sake of simplicity of the description and without limiting the scope of the disclosed embodiments, the identified persona will be referred to a “second persona 125-2”.

In S440, upon identification of the second persona 125-2, it is checked whether the second persona 125-2 allows the content item to be updated. The check in S440 is performed using the user preferences and/or rules defined or otherwise associated with the second persona 125-2. If so, execution continues with S450; otherwise, execution continues with S490. According to a non-limiting example, a business persona is restricted from sharing any or a portion of the updated content item because of security risks.

In S450, it is checked whether to perform an automatic update of the content item with respect the second persona 125-2. If so, execution continues with S480; otherwise, execution continues with S460. The check in S450 is used in the user preferences defined for the second persona 125-2.

In S460, a notification is displayed to the user of the MTP 120 indicating that the update is available. The notification may be displayed on a display of the MTP 120 when the second persona 125-2 runs in the foreground. In S470, in response to the displayed notification, it is checked whether permission to update the content item is received from the user of the MTP 120. If so, execution continues with S480; otherwise, execution continues with S490.

In S480, a link between the second persona 125-2 and the updated content item is generated and the access to the updated content item by the second persona 125-2 is enabled. According to an embodiment, a bind mount links the updated content item and the personas 125-1 and/or 125-2. According to another embodiment, the access to the updated content item by the second persona 125-2 is enabled by means of a common sync protocol, or file system type of link as detailed above.

It should be noted if the content item cannot be updated with respect to the second persona, a link between the un-updated content item and the second persona remains. Thus, at the end of the process the second person is either linked to an updated or original version of the content item. In S490, it is checked whether there are additional requests, and if so execution continues with S410; otherwise, execution terminates.

FIG. 5 shows an exemplary and non-limiting flowchart 500 illustrating a method for removing content items stored by a persona of a MTP according to an embodiment. Without limiting the scope of the disclosed embodiments the method will be described also with references to the various elements illustrated in FIG. 1. Further for the sake of simplicity of the description, the method will be described with to a first persona 125-1 and a second persona 125-2.

In S510, a request to remove a content item previously stored associated with the MTP 120 is received. The request may be sent, e.g., to the agent 126, by a persona 125-1, a component of the MTP 120 that is not a persona 125-1, an external component communicatively connected to the MTP 120, and so on. The content item is saved in a memory space associated with the persona 125-1. For example, the first persona 125-1 can request to delete a picture that was taken by the camera of the MTP 120 or to remove an application installed on the MTP 120.

In S520, it is checked if the content item to be removed is linked to at least one persona of the personas 125-2 through 125-n. The analysis in S520 is performed using the user preferences and/or rules defined or otherwise associated with each of the personas 125-2 through 125-n. If so, execution continues with S530; otherwise, execution continues with S525. In S525, the content item is removed from the memory space associated with the first persona 125-1, and the link between the first persona 125-1 and the content item is deleted. Then, execution continues with S560.

The method reaches S530 when at least one persona is linked to the content item requested to be removed. Merely for the sake of simplicity of the description and without limiting the scope of the disclosed embodiments, the identified persona will be referred to a “second persona 125-2”. In S530, a notification is displayed to the user indicating that an attempt to remove the content item is performed. The notification may be displayed by a persona currently running in the foreground or with respect to a persona (e.g., the second persona 125-2) linked to the content item.

In S540, it is checked whether the user authorizes the removal of the link between the content item and the second persona 125-2, and if so execution continues with S545; otherwise, execution continues with S550. The check in S540 is based on a user input received through an interface (not shown) of the MTP 120 and/or respective of user preferences defined for the second persona 125-2. In S545, the content item is removed and the links between each persona linked to the content item are deleted. Then, execution continues with S560

Execution reaches S550 when the user has not authorized the removal of the content item. As such, in S550, a copy of the content item is associated with a memory space associated with the second persona 125-2. A link between the second persona 125-2 and the content item is generated.

In addition, the link between the first persona 125-1 and the content item is deleted. In S560, it is checked whether there are additional requests and if so execution continues with S510; otherwise, execution terminates.

The various embodiments are implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise a set of elements comprises one or more elements. In addition, terminology of the form “at least one of A, B, or C” or “one or more of A, B, or C” or “at least one of the group consisting of A, B, and C” or “at least one of A, B, and C” used in the description or the claims means “A or B or C or any combination of these elements.” For example, this terminology may include A, or B, or C, or A and B, or A and C, or A and B and C, or 2A, or 2B, or 2C, and so on.

All examples and conditional language recited herein are intended for pedagogical purposes to aid the reader in understanding the principles of the various embodiments and the concepts contributed by the inventor to furthering the art, and are to be construed as being without limitation to such specifically recited examples and conditions. Moreover, all statements herein reciting principles, aspects, and embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for managing content items associated with personas of a multiple-persona mobile technology platform (MTP), comprising:
receiving a request to perform an action on a content item associated with a first persona of a plurality of personas defined in the MTP, wherein the request is generated by the first persona;
identifying at least a second persona of the plurality of personas defined in the MTP is linked to the content item;
performing the requested action, when the at least second persona is not linked to the content item; and
managing a link between the first persona and the content item, when the at least second persona is linked to the content item.

2. The method of claim 1, wherein identifying the at least second persona further comprises:
analyzing user preferences set for each of the plurality of personas.

3. The method of claim 1, wherein each persona in the multiple-persona MTP is a user profile defined as part of an operating system supporting a multiple-user feature of the MTP.

4. The method of claim 1, wherein the action is at least storing the content item in a memory space associated with the first persona.

5. The method of claim 4, wherein the memory space is part of at least one of: a local memory in the MTP and a remote storage device.

6. The method of claim 4, further comprising:
identifying whether the content item was previously associated with the memory space associated with at least second persona;
storing the content item in any one of the memory space associated with the first persona and a shared memory, if the content item was not previously associated with the first persona; and
generating the link between the content item in the memory space of the second persona and the first persona, if the content item was previously associated with the second persona.

7. The method of claim 6, wherein the generated link is at least any one of: a bind mount, a file system link, and a common synchronization protocol link.

8. The method of claim 6, wherein storing the content item further comprises:
binding the associated content item to the first persona to enable access to the associated content item by the first persona.

9. The method of claim 6, wherein the link is generated responsive to at least permissions defined in user preferences of the second persona.

10. The method of claim 9, wherein the user preferences are set by any one of: information technology (IT) personnel, a security policy, a server external to the MTP, and a user of the MTP.

11. The method of claim 1, wherein the action is at least updating the content item associated with the first persona.

12. The method of claim 11, further comprising:
identifying whether the second persona is linked to the content item in the memory space associated with the first persona;
checking if the second persona allows the update of the content item; and
generating the link between the updated content item in any one of: the memory space associated with first persona and the second persona and a shared memory, when the second persona allows the update.

13. The method of claim 12, wherein the checking if the second persona allows the update of the content item is performed responsive to user preferences of the second persona.

14. The method of claim 13, wherein the user preferences are set by any one of: information technology (IT) personnel, a security policy, a server external to the MTP, and a user of the MTP.

15. The method of claim 1, wherein the action is to at least remove the content item associated with the first persona.

16. The method of claim 15, further comprising:
identifying whether the second persona is linked to the content item associated with the first persona;
checking if the second persona allows removal of the content item; and
removing the link between the content item in at any one of: the memory space associated with the first persona and the second persona and a shared memory, when the second persona allows the removal of the first content item.

17. The method of claim 16, further comprising:
storing a copy of the content item in any one of the memory space associated with the second persona and a shared memory; and
binding the stored copy of the content item to the second persona to enable access to the stored copy of the content item by the second persona.

18. The method of claim 1, wherein the at least one content item is any one of:
an application, a service, a file, and a bookmark

19. The method of claim 1, wherein the MTP is any one of: a cellular phone, a smartphone, a tablet device, a notebook computer, a laptop, an intra-vehicle infotainment system (IVI), a wearable computing device.

20. A computer software product containing instructions embodied in a tangible memory that when executed on a computing device performs the method of claim 1.

21. A multiple-persona mobile technology platform (MTP) for managing content items, comprising:
a processing unit; and
a memory, the memory containing instructions that, when executed by the processing unit, configure the MTP to:
receive a request to perform an action on a content item associated with the first persona of a plurality of personas defined in the MTP, wherein the request is generated by the first persona;
identify at least second persona of the plurality of personas defined in the MTP is linked to the content item;
perform the requested action, when the at least second person is not linked to the content item; and
manage a link between the first persona and the content item, when the at least second persona is linked to the content item.

22. The MTP of claim 21, wherein the MTP is further configured to:
analyze user preferences set for each of the plurality of personas.

23. The MTP of claim 21, wherein each persona in the multiple-persona MTP is a user profile defined as part of an operating system supporting a multiple-user feature of the MTP.

24. The MTP of claim 21, wherein the action is at least storing the content item in a memory space associated with the first persona.

25. The MTP of claim 24, wherein the memory space is part of at least one of: a local memory in the MTP and a remote storage device.

26. The MTP of claim 24, wherein the MTP is further configured to:
identify whether the content item was previously associated with the memory space of the at least second persona;
store the content item in any one of the memory space associated with the first persona and a shared memory, if the content item was not previously associated with the first persona; and
generate the link between the content item in the memory space of the second persona and the first persona, if the content item was previously associated with the first persona.

27. The MTP of claim 26, wherein the generated link is at least any one of: a bind mount, a file system link, and a common synchronization protocol link.

28. The MTP of claim 27, wherein the MTP is further configured to:
bind the associated content item to the first persona to enable access to the associated content item by the first persona.

29. The MTP of claim 26, wherein the link is generated responsive to at least permissions defined in user preferences of the second persona.

30. The MTP of claim 29, wherein the user preferences are set by any one of: information technology (IT) personnel, a security policy, a server external to the MTP, and a user of the MTP.

31. The MTP of claim 21, wherein the action is at least updating the content item associated with the first persona.

32. The MTP of claim 31, wherein the MTP is further configured to:
identify whether the second persona is linked to the content item in the memory space associated with first persona;
check if the second persona allows the update of the content item; and
generate the link between the updated content item in any one of: the memory space associated with first persona and the second persona and a shared memory, when the second persona allows the update.

33. The MTP of claim 32, wherein the checking if the second persona allows the update of the content item is performed responsive to user preferences of the second persona.

34. The MTP of claim 33, wherein the user preferences are set by any one of: information technology (IT) personnel, a security policy, a server external to the MTP, and a user of the MTP.

35. The MTP of claim 21, wherein the action is to at least remove the content item associated with the first persona.

36. The MTP of claim 35, wherein the MTP is further configured to:
identify whether the second persona is linked to the content item associated with the first persona;
check if the second persona allows removal of the content item; and
remove the link between the content item in any one of: the memory space associated with the first persona and the second persona and a shared memory, when the second persona allows the removal of the first content item.

37. The MTP of claim 36, wherein the MTP is further configured to:
store a copy of the content item in the memory space associated with the second persona of the MTP; and
bind the stored copy of the content item to the second persona to enable access to the stored copy of the content item by the second persona.

38. The MTP of claim 21, wherein the at least one content item is any one of: an application, a service, a file, and a bookmark

39. The MTP of claim 21, wherein the MTP is any one of: a cellular phone, a smartphone, a tablet device, a notebook computer, a laptop, an intra-vehicle infotainment system (IVI), a wearable computing device.
